(19) United States
(12) Patent Application Publication
(10) Pub. No.: US 2025/0199876 A1
(43) Pub. Date: Jun. 19, 2025

(54) ELECTRONIC DEVICE, METHOD, AND COMPUTER READABLE STORAGE MEDIUM FOR ALLOCATING VIRTUAL MACHINE FOR EXECUTING APPLICATION

(71) Applicant: NCSOFT CORPORATION, Seongnam-si (KR)

(72) Inventors: Youngdal KWAK, Seongnam-si (KR); Donghwan Kim, Seongnam-si (KR); Sanghoon Byun, Seongnam-si (KR); Changyong Lee, Seongnam-si (KR)

(73) Assignee: NCSOFT CORPORATION, Seongnam-si (KR)

(21) Appl. No.: 19/068,185

(22) Filed: Mar. 3, 2025

Related U.S. Application Data
(62) Division of application No. 17/854,631, filed on Jun. 30, 2022.

(30) Foreign Application Priority Data
Jul. 23, 2021 (KR) 10-0096946

(51) Int. Cl. G06F 9/50

(52) U.S. Cl. CPC G06F 9/5077; G06F 9/5016; G06F 9/5033; G06F 9/5038

(57) ABSTRACT

The one or more programs stored in a computer-readable storage medium according to various embodiments include instructions cause the first electronic device to receive, from a third electronic device, a first signal related to a user input to access a character corresponding to a user of the third electronic device through a first connection between the first electronic device and the third electronic device, establish a second connection between the first electronic device and a second electronic device distinct from the third electronic device and third connection for transmission of graphic data from the third electronic device to the second electronic device, transmit a second signal for requesting generation of the graphic data including the character controlled based on the second user input to the second electronic device through the second connection, and control the character independently of the transmission of the graphic data based on the third connection.

### CROSS-REFERENCE TO RELATED APPLICATION(S)

This application is a divisional application of U.S. patent application Ser. No. 17/854,631, filed Jun. 30, 2022, which is based on and claims priority to Korean Patent Application No. 10-2021-0096946, filed on Jul. 23, 2021, in the Korean Intellectual Property Office, the disclosures of which are incorporated herein in their entirety by reference.

### BACKGROUND

### Technical Field

Various embodiments described below relate to an electronic device, a method, and a computer-readable storage medium for allocating a virtual machine for execution of an application.

### Description of Related Art

For application execution of the user device, a server for processing data on the application and a cloud device for generating a screen on the processed data may be used. The user device, the server, and the cloud device may establish a connection, respectively, and may transmit and receive data necessary for executing the application of the user device to and from each other.

### SUMMARY

When an application (e.g., an online game) is executed in a user device, a server may process execution of the application and may transmit the processed data to a cloud device. The cloud device may generate a screen based on the processed data. The cloud device may transmit the generated screen to the user device.

In this case, when the cloud device for generating the screen is insufficient, there may be a problem that the user device is not able to execute the application. In addition, when the cloud device for generating the screen is not prepared in advance, there may be a problem that the user device has to wait for a long time to execute the application.

The technical problems to be achieved in this document are not limited to those described above, and other technical problems not mentioned herein will be clearly understood by those having ordinary knowledge in the art to which the disclosure belongs, from the following description.

According to various embodiments, one or more programs stored in a computer readable storage medium, when being executed by at least one processor of a first electronic device with a communication circuit, may include instructions causing the first electronic device to identify first information indicating a resource of a second electronic device, obtain, based on the first information, second information indicating the number of one or more virtual machines to be executed in the second electronic device, in response to obtaining the second information, transmit a first signal for executing, in a first mode, the number of one or more virtual machines indicated by the second information, to the second electronic device, wherein the first mode is distinct from a second mode in which a virtual machine provides graphic data to one of the external electronic devices, after transmitting the first signal, identify an event for adjusting the number of the one or more virtual machines indicated by the second information; in response to the identification of the event, obtain third information for adjusting the number of the one or more virtual machines executing on the second electronic device, indicated by the second information, and in response to obtaining the third information, transmit to the second electronic device a second signal for adjusting the number of the one or more virtual machines executing in the first mode based on the second information.

According to various embodiments, one or more programs stored in a computer readable storage medium, when being executed by at least one processor of a first electronic device with a communication circuit, may include instructions causing the first electronic device to receive, from a third electronic device distinct from the first electronic device, a first signal related to a user input to access a character corresponding to a user of the third electronic device through a first connection between the first electronic device and the third electronic device, in response to receiving the first signal, establish a second connection between the first electronic device and a second electronic device distinct from the third electronic device and third connection for transmission of graphic data from the third electronic device to the second electronic device, in a first state in which the first connection, the second connection, and the third connection are established, in response to identifying a second user input by the third electronic device through the first connection, transmit a second signal for requesting generation of the graphic data including the character controlled based on the second user input to the second electronic device through the second connection, and in response to identifying entering a second state distinct from the first state, control the character independently of the transmission of the graphic data based on the third connection.

A method for operating a first electronic device with at least one memory and a communication circuit may comprise identifying first information indicating a resource of a second electronic device, obtaining, based on the first information, second information indicating the number of one or more virtual machines to be executed in the second electronic device, in response to obtaining the second information, transmitting a first signal for executing, in a first mode, the number of one or more virtual machines indicated by the second information, to the second electronic device, wherein the first mode is distinct from a second mode in which a virtual machine provides graphic data to one of the external electronic devices, after transmitting the first signal, identifying an event for adjusting the number of the one or more virtual machines indicated by the second information; in response to the identification of the event, obtaining third information for adjusting the number of the one or more virtual machines executing on the second electronic device, indicated by the second information, and in response to obtaining the third information, transmitting to the second electronic device a second signal for adjusting the number of the one or more virtual machines executing in the first mode based on the second information.

A method for operating a first electronic device having at least one memory and communication circuitry, from a third electronic device distinct from the first electronic device, through a first connection between the first electronic device and the third electronic device, may include receiving a first signal related to a first user input for accessing a character corresponding to a user of the third electronic device; in response to the reception of the first signal, establishing a second connection between a second electronic device and the first electronic device, which are distinct from the third electronic device, and a third connection for transmission of graphic data from the third electronic device to the second electronic device; in a first state in which the first connection, the second connection, and the third connection are established, in response to identifying a second user input by the third electronic device through the first connection, to the second electronic device through the second connection, transmitting a second signal for requesting generation of the graphic data including the character controlled based on the second user input; and in response to identifying entering a second state distinct from the first state, controlling the character independently of the transmission of the graphic data based on the third connection.

According to various embodiments, the first electronic device can allocate one or more virtual machines of the second electronic device to execute an application of the third electronic device. In addition, the first electronic device can determine and can adjust the number of one or more virtual machines of various second electronic devices. That is, the first electronic device can adjust the number of one or more virtual machines of the second electronic device according to the operation modes of the external electronic devices including the third electronic device.

The effects that can be obtained from the disclosure are not limited to those described above, and any other effects not mentioned herein will be clearly understood by those having ordinary knowledge in the art to which the disclosure belongs, from the following description.

### BRIEF DESCRIPTION OF THE DRAWING FIGURES

FIG. 1 illustrates an environment including electronic devices according to various embodiments.

FIG. 2 illustrates an example of a first mode of a second electronic device and a third operation mode of a third electronic device according to various embodiments.

FIG. 3 illustrates an example of a second mode of a second electronic device and a first operation mode of a third electronic device according to various embodiments.

FIG. 4 illustrates an example of a first mode of a second electronic device and a second operation mode of a third electronic device according to various embodiments.

FIG. 5 illustrates an example of signaling between electronic devices according to various embodiments.

FIG. 6 illustrates an example of an operation of electronic devices according to various embodiments.

FIG. 7 illustrates an example of signaling between electronic devices according to various embodiments.

FIG. 8 illustrates an example of an operation of electronic devices according to various embodiments.

FIG. 9 illustrates an example of an operation of electronic devices according to various embodiments.

FIG. 10 illustrates an example of a state change of a third electronic device according to various embodiments.

FIG. 11 is a flowchart for illustrating an example of an operation of a first electronic device according to various embodiments.

FIG. 12 is a flowchart for illustrating an example of an operation of a first electronic device according to various embodiments.

FIG. 13 is a flowchart for illustrating an example of an operation of a first electronic device according to various embodiments.

FIG. 14 is a simplified block diagram illustrating functional configurations of each of electronic devices according to various embodiments.

### DETAILED DESCRIPTION

An electronic device according to various embodiments disclosed in the present document may be various types of devices. The electronic device may comprise, for example, a portable communication device (e.g., a smartphone), a computer device, a portable multimedia device, a portable medical device, a camera, a wearable device, a server, or a home appliance. The electronic device according to an embodiment of the present document is not limited to the devices described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,”, “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may be interchangeably used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

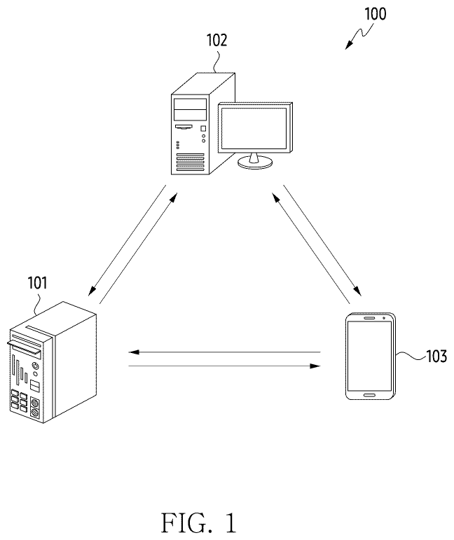

FIG. 1 illustrates an environment including electronic devices according to various embodiments.

Referring to FIG. 1, the environment 100 may comprise a first electronic device 101, a second electronic device 102, and a third electronic device 103.

In various embodiments, the first electronic device 101 may be at least one server that provides a service (e.g., an online game service) for an application (e.g., an online game). For example, the electronic device 101 may comprise an application server, a fee processing server, a database storing user information of the application, a database storing data for executing the application, and a database storing data related to payment transactions caused in the application. According to embodiments, the application server, the fee processing server, the database storing user information, the database storing the data for executing the application, and the database storing the data related to the payment transaction may be implemented as a single physical machine or may be implemented multiple physical machines.

In various embodiments, the application server, based on an interworking with the database storing the data for execution of the application, may process an operation request related to the application received from the third electronic device 103, which is a client device, and may transmit information on a result of the process to the third electronic device 103. In various embodiments, the application server may register a user of the third electronic device 103, which is a client device, based on an interworking with the database storing user information of the application, or may execute authentication of the user based at least on a relation between account information received from the third electronic device 103 and account information stored in the database storing the user information.

In various embodiments, the fee processing server may process a payment transaction caused during execution of the application based on interworking with the database storing the data related to the payment transaction. When the payment transaction is related to an account transfer or a credit card payment, the fee processing server may further interwork with an electronic device for a bank or a credit card company to process the payment transaction.

In various embodiments, the second electronic device 102 may be at least one server that provides a service for executing an application (e.g., generating graphic data regarding an execution screen of the application) based on cloud computing. In various embodiments, the second electronic device 102 may comprise one or more virtual machines for executing an application. The application may be executed through one virtual machine (e.g., a first virtual machine) among the one or more virtual machines. The second electronic device 102 may transmit graphic data related to the execution screen of the application to the third electronic device 103. For example, the graphic data may be directly transmitted to the third electronic device 103 or may be transmitted through the first electronic device 101.

In various embodiments, the second electronic device 102 may operate in one of a first mode and a second mode.

For example, the first mode may comprise a standby mode without providing graphic data to external electronic devices through one or more virtual machines in the second electronic device 102. That is, when the second electronic device 102 operates in the first mode, one or more virtual machines may be executed in the second electronic device 102 but may operate in a standby state.

The second electronic device 102 may wait for generation of graphic data of the third electronic device 103 or may generate graphic data by the first electronic device 101 in both the first mode and the second mode. The owner of the second electronic device 102 may be different from the owner of the first electronic device 101. The first electronic device 101 according to an embodiment may cause a transaction between a user of the third electronic device 103 and a user of the second electronic device 102 in response to using the second electronic device 102 to execute an application of the third electronic device 103. For example, the first electronic device 101 may add at least a part of the amount comprised in the account indicated by the information related to the user of the third electronic device 103 to the amount comprised in the account indicated by the information related to the user of the second electronic device 102. In an embodiment, the first electronic device 101 may add an amount based at least on the time when the second electronic device 102 operates in the first mode and/or the second mode to an amount comprised in the account indicated by information related to the user of the second electronic device 102.

For example, the second mode may comprise a mode for providing graphic data from the second electronic device 102 to external electronic devices (e.g., the third electronic device 103) through one or more virtual machines.

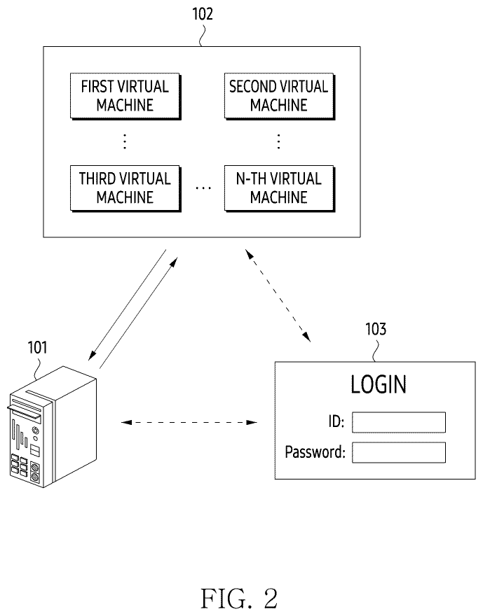

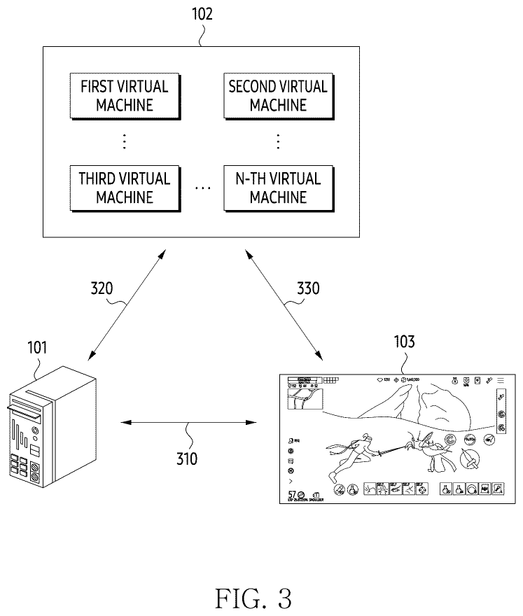

The first mode and the second mode may be called variously. For example, the first mode may be called a standby mode. The second mode may be called an activation mode. Examples of the second electronic device 102 operating in the first mode and the second mode will be described later with reference to FIGS. 2 and 3.

In various embodiments, generating graphic data regarding an execution screen of an application in the second electronic device 102 may be triggered based on a request from the third electronic device 103. The request of the third electronic device 103 may be directly received from the third electronic device 103 or may be received from the third electronic device 103 through the first electronic device 101. However, it is not limited thereto.

In various embodiments, while generating graphic data on the execution screen of the application in the second electronic device 102, the second electronic device 102 may receive a signal for a user input caused in relation to at least one content (e.g., a character) displayed in the third electronic device 103. For example, the signal may be received directly from the third electronic device 103 or may be received from the third electronic device 103 through the first electronic device 101. However, it is not limited thereto.

In various embodiments, the third electronic device 103 may be a client device (e.g., a desktop computer, a laptop computer, a smartphone, a tablet computer, a console, etc.) for a user playing the application. In various embodiments, the third electronic device 103 may be a device that displays an execution screen of the application executed in the third electronic device 103 or executed in the second electronic device 102. In various embodiments, the third electronic device 103 may be a device that receives a user input related to the application through an execution screen of an application executed in the third electronic device 103 or generated through the second electronic device 102.

In various embodiments, when the application is executed, the third electronic device 103 may operate in one of the first operation mode to the third operation mode.

For example, in the first operation mode, the third electronic device 103 may receive graphic data from the second electronic device 102 and may display an execution screen of the application based on the received graphic data.

For another example, the third electronic device 103 may not display an execution screen of the application in the second operation mode. The third electronic device 103 may display a standby screen of the application in the second operation mode. The third electronic device 103 may maintain the user's login state for the application in the second operation mode. In addition, based on a user input, the third electronic device 103 may change the operation mode from the second operation mode to the third operation mode without standby time.

As another example, the third electronic device 103 may display the user's logout state for the application in the third operation mode. The third electronic device 103 may change the operation mode from the third operation mode to the first operation mode based on a user input (e.g., an input for login). When the third electronic device 103 is changed from the third operation mode to the first operation mode, a standby time may occur in the third electronic device 103.

The first operation mode to the third operation mode may be called variously. For example, the first operation mode may be called a streaming activation mode. The second operation mode may be called a resource saving mode. The third operation mode may be called a logout mode.

The first mode and the second mode of the second electronic device 102 described above may be distinct from the first operation mode to the third operation mode of the third electronic device 103. That is, the first mode and the second mode described below may be related to the second electronic device 102. The first operation mode to the third operation mode described below may be related to the third electronic device 103.

For example, the first mode and the second mode of the second electronic device 102, in the second electronic device 102, may be classified based on whether graphic data is provided to the external electronic devices through one or more virtual machines.

For example, the first operation mode to the third operation mode of the third electronic device 103 may be classified based on an execution state of an application executed in the third electronic device 103.

In FIGS. 2 to 4, an example of state of the first electronic device 101 to the third electronic device 103 according to a mode (e.g., the first mode and the second mode) of the second electronic device 102 and an operation mode (e.g., the first operation mode to the third operation mode) of the third electronic device 103 may be illustrated. For convenience of description, in FIGS. 2 to 4, an application executed in the third electronic device 103 may be described as an online game (or a cloud game), which is an example of the application.

FIG. 2 illustrates an example of the first mode of the second electronic device and the third operation mode of the third electronic device according to various embodiments.

Referring to FIG. 2, the first electronic device 101 may establish a connection with the second electronic device 102.

For example, the first electronic device 101 may identify whether the second electronic device 102 is in use. The first electronic device 101 may establish a connection with the second electronic device 102 while the second electronic device 102 is not in use. In other words, the first electronic device 101 may establish a connection with the second electronic device 102 based on the fact that the second electronic device 102 is not in use.

For example, the first electronic device 101 may determine whether a connection with the second electronic device 102 may be established. For example, the time at which the connection with the second electronic device 102 may be established may be determined by the first electronic device 101 or the second electronic device 102. Accordingly, the first electronic device 101 may determine whether the current time is a time at which a connection with the second electronic device 102 may be established. The first electronic device 101 may establish a connection with the second electronic device 102 based on establishing a connection with the second electronic device 102.

After the connection with the second electronic device 102 is established, the first electronic device 101 may identify first information indicating resources of the second electronic device 102. For example, the first information may comprise information on a central processing device of the second electronic device 102, information on a graphic processing device of the second electronic device 102, information on a storage device of the second electronic device 102, and information on a network state of the second electronic device 102.

The first electronic device 101 may obtain second information indicating the number of one or more virtual machines to be executed in the second electronic device 102 based on the first information indicating the resource of the second electronic device 102. In other words, the first electronic device 101 may determine the number of one or more virtual machines to be executed in the second electronic device 102 based on the first information.

The first electronic device 101 may transmit a first signal for executing virtual machines of number (e.g., N) indicated by the second information in the first mode of the second electronic device 102. The second electronic device 102 may receive the first signal.

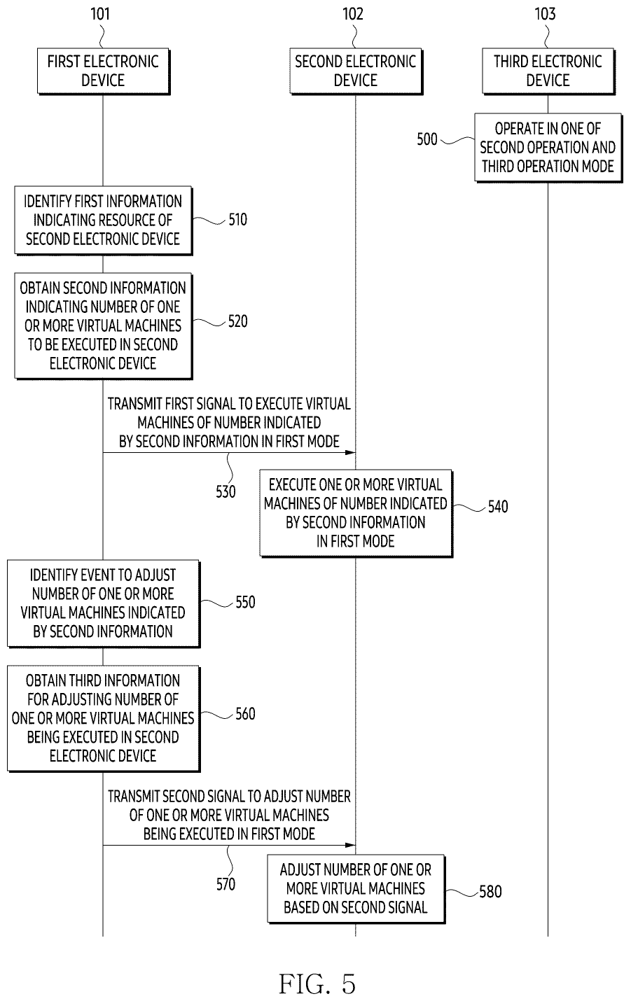

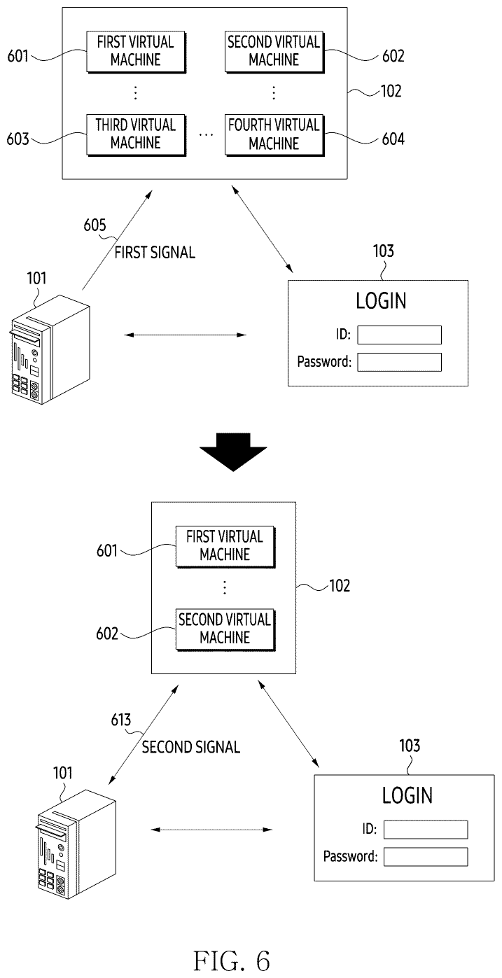

The second electronic device 102 may execute a number (e.g., N) of virtual machines indicated by the second information based on the first signal. The second electronic device 102 may operate in a first mode that does not provide graphic data to external electronic devices (e.g., the third electronic device 103. According to an embodiment, the first electronic device 101 may adjust the number of virtual machines executed in the second electronic device 102 based on an event for adjusting the number of virtual machines. A specific embodiment for adjusting the number of virtual machines executed by the first electronic device 101 in the second electronic device 102 will be described later with reference to FIGS. 5 and 6.

The third electronic device 103 may operate in the third operation mode. For example, the third electronic device 103 may operate in a state in which an online game is executed but a user's login is not performed (or a logout state).

While operating in the third operation mode, the third electronic device 103 may be in a state in which connection with the first electronic device 101 and the second electronic device 102 is not established. The third electronic device 103 may establish a connection with each of the first electronic device 101 and the third electronic device 103 based on a user login. In addition, the operation mode of the third electronic device 103 may be changed from the third operation mode to the first operation mode based on the login of the user.

FIG. 3 illustrates an example of the second mode of the second electronic device and the first operation mode of the third electronic device according to various embodiments.

Referring to FIG. 3, the third electronic device 103 may receive a user input (e.g., a login input). In the third electronic device 103, an online game may be executed based on a user input. Based on the user input, the third electronic device 103 may request the first electronic device 101 to establish a session based on an account indicated by the user input. In response to the request, the first electronic device 101 may establish a session based on the account with the third electronic device 103.

For example, the third electronic device 103 may transmit a first signal for accessing a character corresponding to a user to the first electronic device 101 through a first connection 310 between the first electronic device 101 and the third electronic device 103.

The first electronic device 101 may receive a first signal from the third electronic device 103. The first electronic device 101 may establish a second connection 320 between the first electronic device 101 and the second electronic device 102 in response to the first signal. In addition, the first electronic device 101 may establish a third connection 330 between the second electronic device 102 and the third electronic device 103 in response to the first signal. For example, the first electronic device 101 may transmit a signal for instructing the establishment of the third connection 330 to at least one of the first electronic device 101 and the second electronic device 102. According to an embodiment, the signal for instructing the establishment of the third connection 330 may comprise information related to the third electronic device 103 indicated by the session. A third connection 330 between the second electronic device 102 and the first electronic device 101 may be established based on information related to the third electronic device 103 comprised in the signal.

In the first state in which the first connection 310, the second connection 320, and the third connection 330 are established, the third electronic device 103 may receive a user input for controlling a character corresponding to the user. The third electronic device 103 may transmit a signal indicating that a user input for controlling a character corresponding to the user has been received to the first electronic device 101.

The first electronic device 101 may transmit a second signal requesting generation of graphic data including the character controlled based on a user input to the second electronic device 102.

The second electronic device 102 may change the mode of the second electronic device 102 from the first mode to the second mode in response to the second signal. For example, the second electronic device 102 may generate graphic data including the character through a first virtual machine among one or more executing virtual machines. The second electronic device 102 may transmit the generated graphic data to the third electronic device 103. For example, the second electronic device 102 may directly transmit the generated graphic data to the third electronic device 103. For another example, the second electronic device 102 may transmit the generated graphic data to the third electronic device 103 through the first electronic device 101.

The third electronic device 103 may receive graphic data from the second electronic device 102. For example, in the first operation mode, the third electronic device 103 may receive graphic data from the second electronic device 102 and may display an execution screen of the online game based on the received graphic data.

That is, after receiving a signal indicating that a user input for controlling a character corresponding to the user has been received, the first electronic device 101 may perform data processing for controlling the character. The first electronic device 101 may request the second electronic device 102 to generate graphic data based on the data processing. For example, the first electronic device 101 may transmit a result of data processing to the second electronic device 102. In addition, the first electronic device 101 may request the second electronic device 102 to generate graphic data together with a result of data processing.

The second electronic device 102 may generate graphic data for displaying a character corresponding to the user based on data processing performed in the first electronic device 101. The second electronic device 102 may transmit the generated graphic data to the third electronic device 103. The third electronic device 103 may display a character corresponding to the user on the display of the third electronic device 103 based on the generated graphic data.

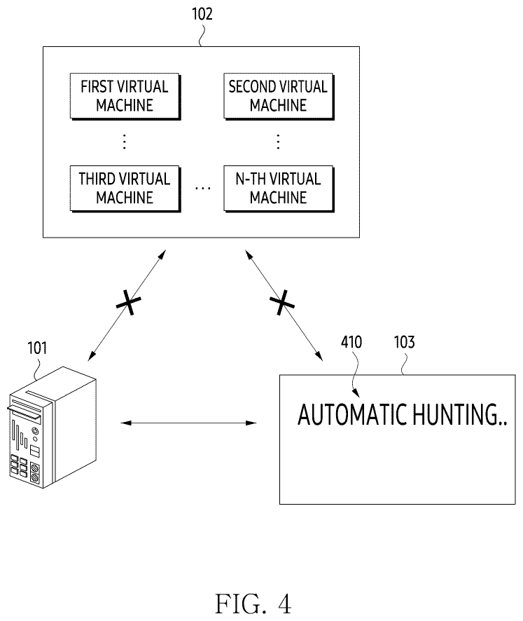

FIG. 4 illustrates an example of a first mode of a second electronic device and a second operation mode of a third electronic device according to various embodiments.

Referring to FIG. 4, in the first operation mode, the third electronic device 103 may receive a user input (e.g., an automatic hunting start to control a character corresponding to the user independently of the user input and/or a power saving mode start to at least temporarily stop displaying graphic data). The third electronic device 103 may change the operation mode of the third electronic device 103 from the first operation mode to the second operation mode based on the user input. The third electronic device 103 may display a screen 410 corresponding to the user input based on the user input. Accordingly, the third electronic device 103 may display the screen 410 in the second operation mode. In the second operation mode, the third electronic device 103 may maintain the user's login state and may stand by for a user input for releasing the second operation mode. Although not illustrated, the screen 410 may comprise information on a time when the second operation mode is maintained. For example, after the time elapses for maintaining the second operation mode, the operation mode of the third electronic device 103 may be changed from the second operation mode to the third operation mode.

For example, in an online game, the user input may be an input for starting automatic hunting (or starting a power saving mode). Based on the user input, the third electronic device 103 may display a screen 410 indicating that it is automatically hunting (or operating in a power saving mode) through a display of the third electronic device 103.

The third electronic device 103 may transmit a signal indicating the user input to the first electronic device 101.

The first electronic device 101 may release the second connection between the first electronic device 101 and the second electronic device 102 based on the signal indicating the user input. For example, the first electronic device 101 may transmit a signal requesting the second electronic device 102 to stop generating graphic data, and may release the second connection.

Based on the signal, the second electronic device 102 may stop generating graphic data to the third electronic device 103. The second electronic device 102 may change the mode of the second electronic device 102 from the second mode for generating and providing graphic data to the first mode.

The first electronic device 101 may release the third connection between the second electronic device 102 and the third electronic device 103 based on the signal indicating the user input. For example, the first electronic device 101 may transmit a signal for requesting the release of the third connection to the second electronic device 102. The first electronic device 101 may transmit a signal for requesting release of the third connection to the third electronic device 103.

FIG. 5 illustrates an example of signaling between electronic devices according to various embodiments.

Referring to FIG. 5, in operation 500, while operation 510 to operation 580 are being performed, the third electronic device 103 may operate in one of the second operation mode and the third operation mode.

In operation 510, the first electronic device 101 may identify first information indicating a resource of the second electronic device 102.

For example, the information indicating the resource may comprise information on the central processing device of the second electronic device 102, information on the graphic processing device of the second electronic device 102, information on a storage device of the second electronic device 102 and information on a network state of the second electronic device 102.

As an example, the information on the central processing device of the second electronic device 102 may comprise information on an architecture type, the number of cores, a cache memory capacity, a cache memory level, a vendor name, a produce name, or an operating frequency etc.

As an example, the information on the graphic processing apparatus of the second electronic device 102 may comprise information on an architecture type, the number of cores, cache memory capacity, or a graphic random access memory (GRAM) size etc.

As an example, the information on the storage device of the second electronic device 102 may comprise information on a bandwidth, a static random access memory (SRAM) size, or an operating frequency etc.

As an example, the information on the network state of the second electronic device 102 may comprise information on bandwidth or speed.

In operation 520, the first electronic device 101 may obtain second information indicating the number of one or more virtual machines to be executed in the second electronic device 102.

According to an embodiment, the first electronic device 101 may set total grade information of the second electronic device 102 based on the first information to identify the number of one or more virtual machines to be executed in the second electronic device 102.

For example, the first electronic device 101 may set first grade information based on information on the central processing device of the second electronic device 102, second grade information based on information on the graphic processing device of the second electronic device 102, third grade information based on information on the storage device of the second electronic device 102, and fourth grade information based on information on the network state of the second electronic device 102. For example, each of the first grade information to the fourth grade information may be set to one of four grades. The four grades may comprise S grade, A grade, B grade, and C grade. Among the four grades, the highest grade may be set to the S grade, and the lowest grade may be set to the C grade.

For example, the first electronic device 101 may set first grade information to fourth grade information on the second electronic device 102 among the second electronic devices 102. The first electronic device 101 may set the first grade information of the second electronic device 102 to the S grade. The first electronic device 101 may set the second grade information of the second electronic device 102 to the A grade. The first electronic device 101 may set the third grade information of the second electronic device 102 to the B grade. The first electronic device 101 may set the fourth grade information of the second electronic device 102 to the C grade.

For example, the first electronic device 101 may set (or determine) the lowest grade information among the first grade information to the fourth grade information of the second electronic device 102 as the total grade information of the second electronic device 102. Accordingly, in the above-described example, the first electronic device 101 may set the total grade information of the second electronic device 102 to the C grade.

For another example, the first electronic device 101 may set (or determine) an average grade of the first grade information to the fourth grade information of the second electronic device 102 as total grade information of the second electronic device 102. Accordingly, in the above-described example, the first electronic device 101 may set the total grade information of the second electronic device 102 to the B grade.

According to an embodiment, the first electronic device 101 may obtain second information indicating the number of one or more virtual machines to be executed in the second electronic device 102 based on the total grade information of the second electronic device 102.

The first electronic device 101 may determine the number of one or more virtual machines to be executed in the second electronic device 102 for each grade of the total grade information of the second electronic device 102.

For example, when the total grade information of the second electronic device 102 is grade S, the number of one or more virtual machines to be executed in the second electronic device 102 may be set to N1. For another example, when the total grade information of the second electronic device 102 is grade A, the number of one or more virtual machines to be executed in the second electronic device 102 may be set to N2. For another example, when the total grade information of the second electronic device 102 is grade B, the number of one or more virtual machines to be executed in the second electronic device 102 may be set to N3. For another example, when the total grade information of the second electronic device 102 is grade C, the number of one or more virtual machines to be executed in the second electronic device 102 may be set to N4. As the total grade information of the second electronic device 102 is higher, the greater number of virtual machines may be allocated. Accordingly, in the above-described examples, values of NI to N4 may be set as N1>N2>N3>N4, respectively.

In operation 530, in response to obtaining of the second information, the first electronic device 101 may transmit a first signal for executing the number of virtual machines indicated by the second information in the first mode to the second electronic device.

For example, the first electronic device 101 may set the number of one or more virtual machines to be executed in the second electronic device 102 to N. Accordingly, the first electronic device 101 may transmit a first signal for executing the N virtual machines in the first mode.

In operation 540, the second electronic device 102 may execute one or more virtual machines of number indicated by the second information in the first mode. For example, when the number indicated by the second information is N, the second electronic device 102 may execute N virtual machines in the first mode. In other words, the second electronic device 102 may execute N virtual machines, but the second electronic device 102 may operate in the first mode in which graphic data is not provided.

In operation 550, the first electronic device 101 may identify an event for adjusting the number of one or more virtual machines indicated by the second information.

The event may comprise a first electronic device 101 and/or a user's operation to change a user's state. The event may comprise an electronic device (for example, a second electronic device 102 or a third electronic device 103) detectable by the first electronic device 101 and/or an operation of a user. The first electronic device 101 according to an embodiment may execute instructions referred to as event handlers in response to identifying the event.

For example, the event may comprise an event that is switched from the first time interval to the second time interval. As an example, within the first time interval, the second electronic device 102 may execute the number of virtual machines indicated by the second information in the first mode. In the second electronic device 102, while the number of virtual machines indicated by the second information is being executed in the first mode, the first electronic device 101 may identify switching from the first time interval to the second time interval.

For example, the first time interval and the second time interval may be preset and set. The first time interval and the second time interval may be preset based on time or date. As an example, the first time interval may be set from 12 a.m. to 6 p.m. The second time interval may be set from 6 p.m. to 12 p.m.

For another example, the first time interval and the second time interval may be determined (or set) by the first electronic device 101. The first electronic device 101 may learn data related to operation modes of external electronic devices including the third electronic device 103 based on a machine learning model. Learning of machine learning models, based on supervised learning and/or non-supervised learning, may comprise adjusting the weight between a plurality of nodes comprised in the neural network (e.g., feedforward neural network, Convolution Neural Network (CNN), Recurrent Neural Network (RNN), and/or Long-Short Term Memory Model (LSTM)). The first time interval and the second time interval may be determined by the first electronic device 101 based on the learned data.

The first electronic device 101 may learn a time interval in which the external electronic devices operate in the first operation mode the most and a time interval in which the external electronic devices operate in the first operation mode the least. The first electronic device 101 may predict (or identify) the number (or ratio) of external electronic devices operating in the first operation mode in the second time interval based on the learned data. The first electronic device 101 may predict (or identify) that the number of external electronic devices operating in the first operation mode in the second time interval is greater than the number of external electronic devices operating in the first operation mode in the first time interval. Accordingly, the first electronic device 101 may adjust the number of virtual machines executed in the second electronic device 102 in the second time interval.

For example, the first time interval and the second time interval may be determined based on the number of one or more subscribers accessing a service (e.g., an online game service) corresponding to an application (e.g., an online game) executed by the third electronic device 103. For example, the number of one or more subscribers accessing the service in the first time interval may be relatively large. The number of one or more subscribers accessing the service in the second time interval may be relatively small.

The first electronic device 101 may determine the total number of virtual machines including virtual machines executed in the second electronic device 102 executed in the first time interval. For example, in the first time interval in which the number of subscribers connected to a service related to an application executed in the third electronic device 103 is relatively large, the first electronic device 101 may determine the total number of virtual machines based on the number of applying the first ratio (e.g., 130%) to the number of subscribers accessing the service. The first electronic device 101 may adjust the number of virtual machines executed in the first interval in the second electronic device 102 based on the total number of virtual machines.

In addition, the first electronic device 101 may determine the total number of virtual machines including virtual machines executed in the second electronic device 102 executed in the second interval. For example, in the second time interval in which the number of subscribers accessing a service related to an application executed in the third electronic device 103 is relatively small, the first electronic device 101 may determine the total number of virtual machines based on a number obtained by applying the second ratio (e.g., 110% and/or 105%) distinct from the first ratio to the number of subscribers accessing the service. For example, the first time interval may comprise a time interval in which an event designated by a service provider of the service occurs. For example, the second time interval may comprise a time interval distinct from the first time interval. The first electronic device 101 may adjust the number of virtual machines executed in the second interval in the second electronic device 102 based on the total number of virtual machines.

In operation 560, the first electronic device 101 may obtain third information for adjusting the number of one or more virtual machines executed in the second electronic device 102. For example, the first electronic device 101, in response to the identification of the event, may be indicated by the second information, and may obtain third information for adjusting the number of one or more virtual machines executed in the second electronic device 102.

In operation 570, the first electronic device 101 may transmit a second signal for adjusting the number of one or more virtual machines being executed in the first mode. For example, in response to obtaining the third information, the first electronic device 101 may transmit a second signal for adjusting the number of one or more virtual machines being executed in the first mode based on the third information to the second electronic device.

For example, the first electronic device 101 may transmit the second signal through a connection (e.g., a second connection) between the first electronic device 101 and the second electronic device 102.

In operation 580, the second electronic device 102 may adjust the number of one or more virtual machines based on the second signal.

FIG. 6 illustrates an example of an operation of electronic devices according to various embodiments.

Referring to FIG. 6, the third electronic device 103 may be disconnected from the third electronic device 103. In addition, the third electronic device 103 may operate in the third operation mode.

The first electronic device 101 may identify first information indicating resources of the second electronic device 102. The first electronic device 101 may determine the total grade information of the second electronic device 102 based on the first information indicating the resource of the second electronic device 102. The first electronic device 101 may determine the number of virtual machines to be executed in the second electronic device 102 based on the total grade information of the second electronic device 102. For example, the first electronic device 101 may determine the number of virtual machines to be executed in the second electronic device 102 to be four. The first electronic device 101 may obtain second information indicating the number (i.e., four) of virtual machines to be executed in the second electronic device 102.

The first electronic device 101 may transmit a first signal 605 for executing four virtual machines in the first mode to the second electronic device 102. The second electronic device 102 may receive the first signal 605.

The second electronic device 102 may execute four virtual machines in the second electronic device 102 based on the first signal 605. For example, the second electronic device 102 may execute the first virtual machine 601, the second virtual machine 602, the third virtual machine 603, and the fourth virtual machine 604 in the first mode. In other words, the second electronic device 102 may execute the first virtual machine 601 to the fourth virtual machine 604 and may operate in the first mode.

The first electronic device 101 may identify an event for adjusting the number of virtual machines of the number (i.e., four) indicated by the second information.

For example, the first electronic device 101 may identify that the first time interval is switched to the second time interval. For example, in the first time interval, the number of virtual machines executed in the second electronic device 102 may be set to four. In the second time interval, the number of virtual machines executed in the second electronic device 102 may be set to two.

In response to the identification of the event, the first electronic device 101 may obtain third information for adjusting the number of one or more virtual machines indicated by the second information and being executed in the second electronic device 102. example, the first electronic device 101 may obtain third information for adjusting the number of virtual machines being executed in the second electronic device 102 from four to two.

The first electronic device 101, in response to obtaining the third information, may transmit to the second electronic device 102 a second signal 613 for adjusting the number of one or more virtual machines being executed in the first mode based on the second information. For example, the second signal 613 may correspond to the second signal of operation 570 of FIG. 5. For example, in response to obtaining the third information, the first electronic device 101 may transmit a second signal 613 for adjusting the number of virtual machines being executed in the first mode from four to two to the second electronic device 102.

The second electronic device 102 may adjust the number of virtual machines executed in the second electronic device 102 from four to two based on the second signal 613. For example, the second electronic device 102 may stop execution of the third virtual machine 603 and the fourth virtual machine 604 among the first virtual machine 601 to the fourth virtual machine 604. In other words, the second electronic device 102 may maintain only execution of the first virtual machine 601 and the second virtual machine 602 among the first virtual machines 601 to the fourth virtual machines 604.

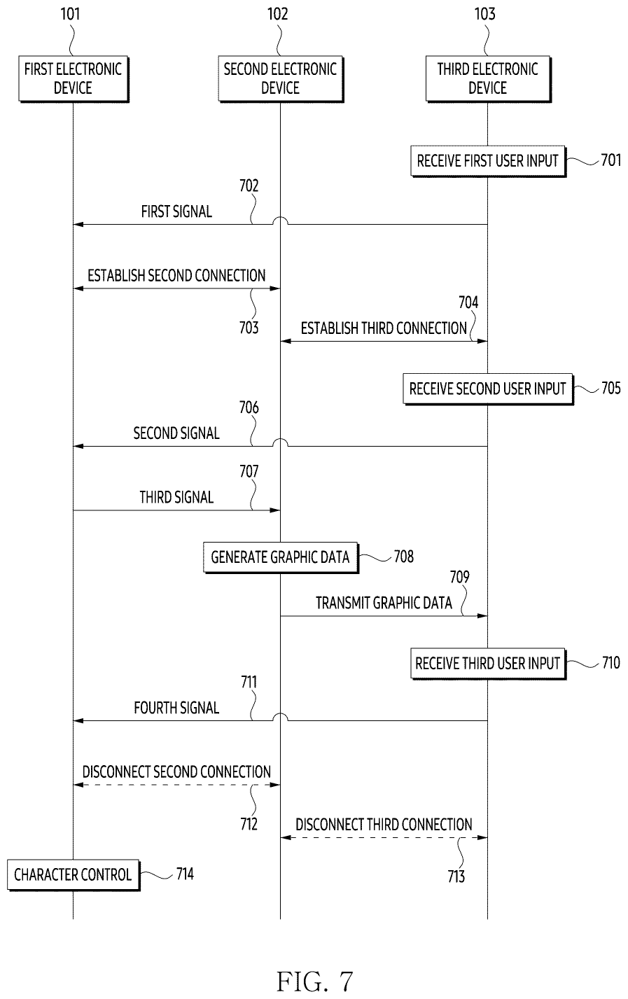

FIG. 7 illustrates an example of signaling between electronic devices according to various embodiments.

Referring to FIG. 7, in operation 701, the third electronic device 103 may receive a first user input for accessing a character corresponding to a user of the third electronic device 103. For example, the first user input may comprise a user's login input for accessing the character.

For example, the third electronic device 103 may establish a first connection with the first electronic device 101 based on the first user input. For another example, the third electronic device 103 may receive a first user input in a state in which a first connection with the first electronic device 101 is established.

In operation 702, the third electronic device 103 may transmit a first signal regarding a first user input for accessing a character corresponding to a user of the third electronic device 103 through a first connection. In other words, the first electronic device 101 may receive the first signal through a first connection.

In operation 703, the first electronic device 101 may establish a second connection on the first electronic device 101 and the second electronic device 102 in response to reception of the first signal. For example, the second connection may be used to transmit information on the control of the character.

In operation 704, the first electronic device 101 may establish a third connection on the second electronic device 102 and the third electronic device 103 in response to reception of the first signal. The third connection may be used to transmit graphic data from the third electronic device 103 to the second electronic device 102.

For example, the first electronic device 101 may transmit information about the third electronic device 103 to the second electronic device 102. The first electronic device 101 according to an embodiment may transmit at least a part of a session corresponding to the first connection to the second electronic device 102 as information on the third electronic device 103. For example, the first electronic device 101 may transmit a parameter (e.g., the IP address of the third electronic device 103, the MAC address, and/or the port number for receiving the graphic data assigned by the operating system of the third electronic device 103) used to connect to the third electronic device 103 among information comprised in the session to the second electronic device 102. For example, the first electronic device 101 may transmit information for establishing a connection with the third electronic device 103 to the second electronic device 102 through a second connection. As another example, the first electronic device 101 may transmit information for allocating the third electronic device 103 to the virtual machine of the second electronic device 102 through a second connection.

Based on the information on the third electronic device 103, the second electronic device 102 may establish a third connection with the third electronic device 103.

In operation 705, the third electronic device 103 may receive a second user input. For example, the third electronic device 103 may receive a second user input for controlling the character. The second user input may be variously configured. For example, the second user input may comprise an input related to the motion of the character in the online game, an input related to the character's attack, an input related to the character's defense, or an input related to the character's conversation.

In operation 706, the third electronic device 103 may transmit the second signal regarding the second user input to the first electronic device 101. In other words, the first electronic device 101 may receive the second signal from the third electronic device 103. The first electronic device 101 may perform data processing for controlling the character based on the second signal. For example, the first electronic device 101 may perform data processing for controlling the character based on a second user input. The first electronic device 101 may perform data processing for changing a motion of the character according to a second user input.

In operation 707, the first electronic device 101 may transmit a third signal for requesting generation of graphic data including a controlled character based on a second user input to the second electronic device 102. For example, the first electronic device 101 may perform data processing for controlling the character and may transmit a third signal including the performed result (or result value) to the second electronic device 102.

In operation 708, the second electronic device 102 may generate graphic data including a controlled character based on a second user input. For example, the second electronic device 102 may receive a result of performing data processing for character control from the first electronic device 101 and may generate graphic data based on the received result.

In operation 709, the second electronic device 102 may transmit the generated graphic data to the third electronic device 103. In other words, the third electronic device 103 may receive graphic data generated from the second electronic device 102. The third electronic device 103 may display the generated graphic data through a display of the third electronic device 103.

In operation 710, the second electronic device 102 may receive a third user input. The third user input may comprise an input for changing an operation mode of the third electronic device 103. For example, the third electronic device 103 may receive a third user input for changing the operation mode of the third electronic device 103 from the first operation mode to the second operation mode. For example, the third electronic device 103 may receive a third user input for maintaining access to the character without displaying the execution of the online game.

In operation 711, the third electronic device 103 may transmit a fourth signal regarding the third user input. In other words, the first electronic device 101 may receive the fourth signal regarding the third user input from the third electronic device 103.

In operation 712, the first electronic device 101 may release the second connection between the first electronic device 101 and the second electronic device 102 based on the fourth signal. For example, the first electronic device 101 may transmit a signal for requesting to stop generation and transmission of the graphic data to the second electronic device 102 based on the fourth signal. Thereafter, the first electronic device 101 may release the second connection with the second electronic device 102.

In operation 713, the first electronic device 101 may release the third connection between the second electronic device 102 and the third electronic device 103 based on the fourth signal. The first electronic device 101 may transmit a signal for requesting release of the third connection to the second electronic device 102 together with release of the second connection. Thereafter, the second electronic device 102 may release the connection with the third electronic device 103. After the third connection is released, the second electronic device 102 may not transmit graphic data to the third electronic device 103.

The third electronic device 103 may operate in the third operation mode based on the release of the third connection. For example, the third electronic device 103 may maintain access to the character without displaying the execution of the online game.

In operation 714, the first electronic device 101 may control the character independently of transmission of graphic data based on the third connection. Even if a second user input for controlling the character is not received, the first electronic device 101 may control the character based on a designated condition. For example, the designated condition may be designated by a user of the third electronic device 103 or may be a state stored in the first electronic device 101.

Accordingly, even when the control screen of the character is not displayed in the third electronic device 103, the first electronic device 101 may control the character until receiving an input for changing the operation mode of the third electronic device 103.

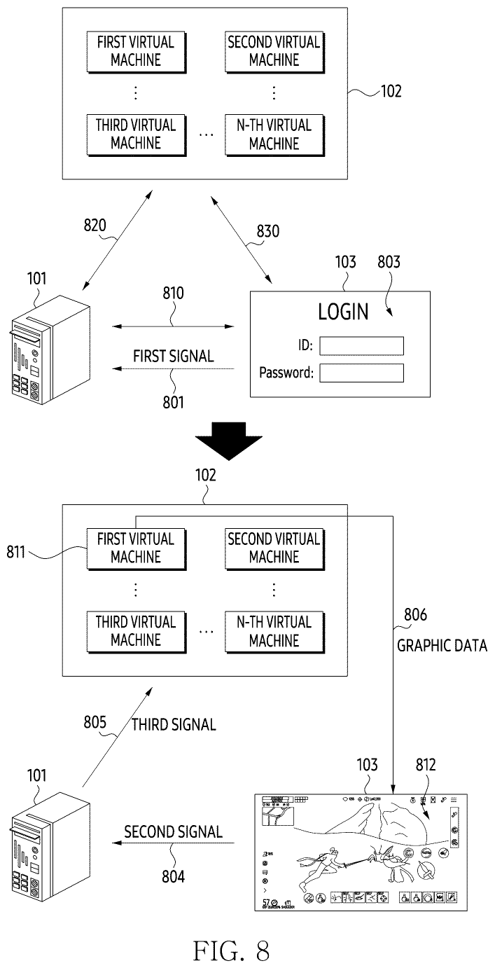

FIG. 8 illustrates an example of an operation of electronic devices according to various embodiments.

Referring to FIG. 8, the third electronic device 103 may operate in a third operation mode. For example, the third electronic device 103 may operate in the third operation mode before a user of the third electronic device 103 accesses a character in an online game corresponding to the user. As an example, the third electronic device 103 may display a screen 803 for the user to access the character on the display of the third electronic device 103.

The third electronic device 103 may receive a first user input for accessing a character corresponding to the user. For example, the third electronic device 103 may receive a first user input for logging in to an online game.

The third electronic device 103 may transmit the first signal 801 regarding the first user input to the first electronic device 101.

For example, the first signal 801 may comprise information on the login of the user. The information on the user's login may comprise user ID information and user password information.

For another example, the first signal 801 may comprise a signal for establishing a first connection 810 with the first electronic device 101. The connection with the first electronic device 101 may be used to request data processing related to control of a controlled character based on a user input of the third electronic device 103. The first electronic device 101 may establish a first connection 810 with the third electronic device 103 based on the first signal.

The first electronic device 101 may request a connection from the second electronic device 102. The connection request may comprise a second connection 820 request between the first electronic device 101 and the second electronic device 102 and a third connection 830 request between the second electronic device 102 and the third electronic device 103.

Based on the first signal, the first electronic device 101 may establish a second connection 820 between the first electronic device 101 and the second electronic device 102. In addition, the first electronic device 101 may establish a third connection 830 between the second electronic device 102 and the third electronic device 103.

The first electronic device 101 may establish a second connection 820 and may allocate a first virtual machine 811 among N virtual machines being executed in the second electronic device 102 as a virtual machine for transmitting graphic data to the third electronic device 103. The second electronic device 102 may generate graphic data for the third electronic device 103 through the first virtual machine 811, and may transmit the graphic data to the third electronic device 103.

After the first connection 810, the second connection 820, and the third connection 830 are established, the third electronic device 103 may change the operation mode from the third operation mode to the first operation mode.

The third electronic device 103 may receive a second user input in the first operation mode. For example, the third electronic device 103 may receive a second user input for controlling a character in an online game.

The third electronic device 103 may transmit the second signal 804 regarding the second user input to the first electronic device 101. The first electronic device 101 may receive the second signal 804 regarding the second user input from the third electronic device 103.

The first electronic device 101 may perform data processing for controlling the character based on the second signal 804. For example, the first electronic device 101 may control the motion of the character or perform data processing for controlling backgrounds or objects related to the character.

The first electronic device 101 may perform data processing for controlling the character and may transmit a third signal 805 including the performed result to the second electronic device 102. The second electronic device 102 may receive the third signal from the first electronic device 101.

The second electronic device 102 may generate graphic data 806 including a character controlled based on a second user input through the first virtual machine 811 based on the third signal 805. For example, the second electronic device 102 may receive a result of performing data processing for character control from the first electronic device 101 and may generate graphic data 806 through the first virtual machine 811 based on the received result.

The third electronic device 103 may receive the graphic data 806 generated from the second electronic device 102. Based on the graphic data 806, the third electronic device 103 may display the screen 812 through the display of the third electronic device 103. The screen 812 may comprise a character controlled based on a second user input.

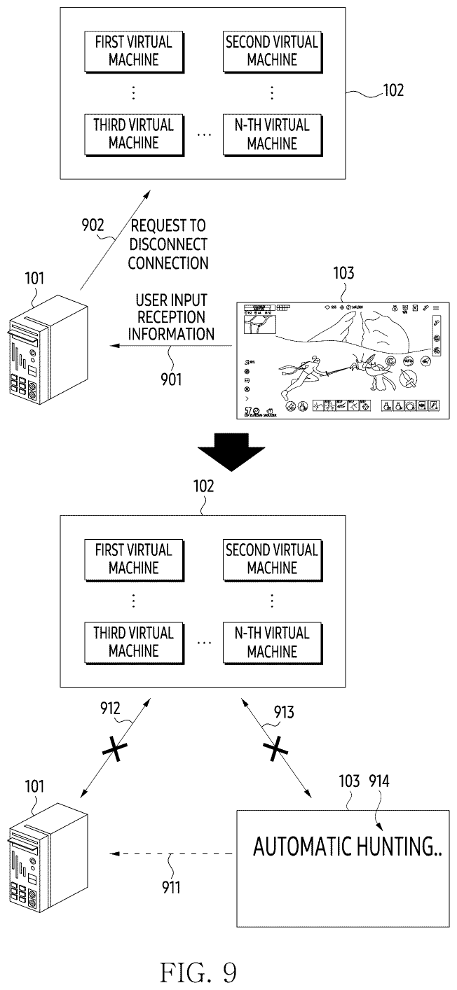

FIG. 9 illustrates an example of an operation of electronic devices according to various embodiments.

Referring to FIG. 9, the third electronic device 103 may operate in a first operation mode. For example, the third electronic device 103 may operate in a first operation mode in which a user of the third electronic device 103 controls a character in an online game corresponding to the user.

The third electronic device 103 may receive a user input for changing the operation mode of the third electronic device 103 from the first operation mode to the second operation mode. In the second operation mode, the third electronic device 103 may maintain access to the character without displaying execution of the online game. For example, the third electronic device 103 may receive a user input for requesting automatic hunting (or power saving mode) in an online game. As an example, in the online game, the third electronic device 103 may receive a user input for setting that the login state is maintained but a screen change regarding the user's character is not performed.

The third electronic device 103 may transmit the reception information 901 of the user input to the first electronic device 101. In other words, the first electronic device 101 may receive the reception information 901 of the user input from the third electronic device 103.

The first electronic device 101 may transmit a signal for a connection release request 902 to the second electronic device 102 based on the reception information 901 of the user input. The connection release request 902 may comprise a request for releasing a second connection 912 between the first electronic device 101 and the second electronic device 102 and a third connection 913 between the second electronic device 102 and the third electronic device 103.

For example, the first electronic device 101 may transmit a signal for stopping the operation of the first virtual machine used to transmit graphic data to the third electronic device 103 among one or more virtual machines of the second electronic device 102. Based on the signal, the second electronic device 102 may stop the operation of the first virtual machine and may release the third connection 913 with the third electronic device 103.

In a state in which the second connection 912 and the third connection 913 are released, the third electronic device 103 may display a screen 914 indicating that the second operation mode is being operated through the display of the third electronic device 103. For example, the third electronic device 103 may display a screen 914 for indicating that automatic hunting is being performed through the display of the third electronic device 103. As another example, the third electronic device 103 may display a screen 914 indicating that automatic hunting is being performed in the power saving mode through the display of the third electronic device 103. For example, the screen 914 may display a state in which a character corresponding to the user of the third electronic device 103 is controlled independently of a user input.

The first electronic device 101 may control the character independently of transmission of graphic data based on the third connection 913. Even if a user input for controlling the character is not received, the first electronic device 101 may control the character based on a designated condition.

Accordingly, even when the control screen of the character is not displayed in the third electronic device 103, the first electronic device 101 may control the character until receiving an input for changing the operation mode of the third electronic device 103.

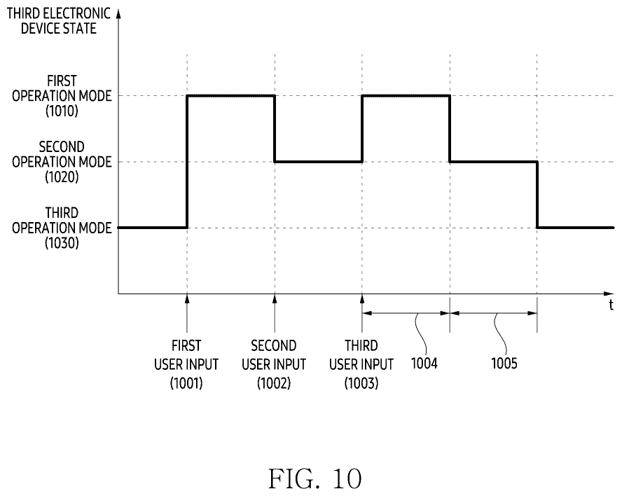

FIG. 10 illustrates an example of a state change of a third electronic device according to various embodiments.

Referring to FIG. 10, the third electronic device 103 may operate in a third operation mode 1030. For example, the third electronic device 103 may operate in the third operation mode 1030 before a user of the third electronic device 103 accesses a character in an online game corresponding to the user.

The third electronic device 103 may receive the first user input 1001. The first user input 1001 may comprise an input for the user to perform access to the character. For example, the third electronic device 103 may receive a first user input 1001 for logging in to the online game.

The third electronic device 103 may change the operation mode of the third electronic device 103 from the third operation mode 1030 to the first operation mode 1010 based on the first user input 1001. For example, the third electronic device 103 may operate in a first operation mode 1010 for controlling the character after accessing the character of the user.

In the first operation mode 1010, the third electronic device 103 may receive a user input for controlling the user's character. The first electronic device 101 may perform data processing on a user input for controlling the user's character. The second electronic device 102 may generate graphic data through the first virtual machine based on the data processing result.

The third electronic device 103 may receive graphic data generated through the first virtual machine from the second electronic device 102. The third electronic device 103 may display a screen through a display of the third electronic device 103 based on graphic data generated through the first virtual machine.

While operating in the first operation mode 1010, the third electronic device 103 may receive a second user input 1002. The second user input 1002 may comprise an input for changing the operation mode of the third electronic device 103 from the first operation mode 1010 to the second operation mode 1020.

The third electronic device 103 may change the operation mode of the third electronic device 103 from the first operation mode 1010 to the second operation mode 1020 based on the second user input 1002. When the operation mode of the third electronic device is changed to the second operation mode 1020, the third electronic device 103 may be released from the second electronic device 102. Accordingly, the third electronic device 103 may not receive graphic data generated through the first virtual machine of the second electronic device 102.

While the third electronic device 103 is operating in the second operation mode 1020, the third electronic device 103 may receive a third user input 1003. The third user input 1003 may comprise a user input for changing the operation mode of the third electronic device 103 from the second operation mode 1020 to the first operation mode 1030.

Based on the third user input 1003, the third electronic device 103 may change the operation mode of the third electronic device 103 from the second operation mode 1020 to the first operation mode 1010.

According to an embodiment, when the operation mode of the third electronic device 103 is changed to the first operation mode 1010 again, the first virtual machine of the second electronic device 102 may be used again. The second electronic device 102 may allocate the first virtual machine to generate graphic data including the character based on the change of the operation mode of the third electronic device 103 to the first operation mode 1010 again.

According to an embodiment, when the operation mode of the third electronic device 103 is changed back to the first operation mode 1010, the third electronic device 103 may establish a connection with another electronic device that is distinct from the second electronic device 102 rather than the second electronic device 102. For example, based on the change of the operation mode of the third electronic device 103 to the first operation mode 1010, the first electronic device 101 may allocate another electronic device distinct from the second electronic device 102 to generate graphic data. Accordingly, the third electronic device 103 may establish a connection with the other electronic device. In addition, a second virtual machine executed in the other electronic device may be allocated to generate graphic data including the character. The third electronic device 103 may receive graphic data generated through the second virtual machine executed in the other electronic device and may display a screen through the display of the third electronic device 103 based on the graphic data generated through the second virtual machine.

According to the embodiment, based on the third user input 1003, an electronic device for displaying graphic data may be allocated to the second electronic device 102 or another electronic device distinct from the second electronic device 102. The second electronic device 102 or another electronic device may be in a state of executing at least one virtual machine and operating in the first mode. Accordingly, based on the third user input 1003, the third electronic device 103 may receive graphic data from the second electronic device 102 or another electronic device without a delay time and may display a screen.

After the third user input 1003 is received, the third electronic device 103 may not receive the user input during the first time interval 1004. The third electronic device 103 may change the operation mode of the third electronic device 103 from the first operation mode 1010 to the second operation mode 1020 based on not receiving a user input during the first time interval 1004.

After the first time interval 1004 has elapsed, the third electronic device 103 may not receive a user input during the second time interval 1005. The third electronic device 103 may change the operation mode of the third electronic device 103 from the second operation mode 1020 to the third operation mode 1030 based on not receiving a user input during the second time interval 1005. For example, the length of the second time interval 1005 may correspond to a designated threshold for changing the operation mode of the third electronic device 103 to the third operation mode 1030. Referring to FIG. 10, the length of the time interval between the third user input 1003 and the second user input 1002 may be less than the length of the second time interval 1005. In an embodiment, the second time interval 1005 may be indicated by a session corresponding to the first connection established between the first electronic device 101 and the third electronic device 103. For example, the third electronic device 103 may enter the third operation mode 1030 from the second operation mode 1020 in response to identifying the expiration of the second time interval 1005 indicated by the session.

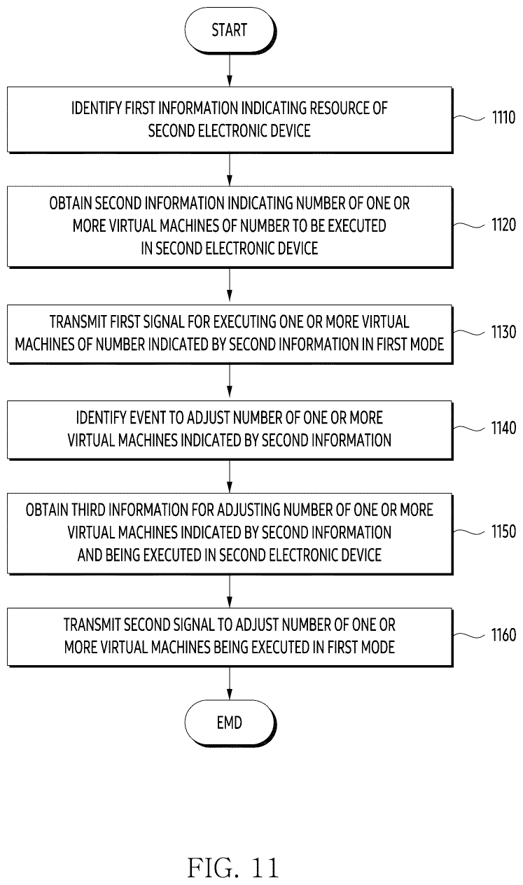

FIG. 11 is a flowchart illustrating an example of an operation of a first electronic device according to various embodiments.

Referring to FIG. 11, in operation 1110, the first electronic device 101 (e.g., the processor of the first electronic device 101) may identify first information indicating resources of the second electronic device 102.

For example, the first information may comprise information on a central processing device of the second electronic device 102, information on a graphic processing device of the second electronic device 102, information on a storage device of the second electronic device 102, and information on a network state of the second electronic device 102.

For example, the first electronic device 101 may receive the first information from the second electronic device 102. The first electronic device 101 may periodically receive the first information from the second electronic device 102 or may aperiodically receive the first information based on receiving a user input or changing a mode of the second electronic device 102.

In operation 1120, the first electronic device 101 may obtain second information indicating the number of one or more virtual machines to be executed in the second electronic device 102 based on the first information.

For example, the first electronic device 101 may identify the total grade information of the second electronic device 102 to obtain the second information.

The first electronic device 101 may identify first grade information based on information on the central processing device of the second electronic device 102. The first electronic device 101 may identify second grade information based on information on the graphic processing device of the second electronic device 102. The first electronic device 101 may identify third grade information based on information on the storage device of the second electronic device 102. The first electronic device 101 may identify fourth grade information based on information on the network state of the second electronic device 102. The first electronic device 101 may identify total grade information of the second electronic device 102 based on the first grade information to the fourth grade information.

As an example, the first electronic device 101 may identify the total grade information of the second electronic device 102 with the lowest grade among the first grade information to the fourth grade information. As another example, the first electronic device 101 may identify the total grade information of the second electronic device 102 with the highest grade among the first grade information to the fourth grade information. As another example, the first electronic device 101 may identify total grade information of the second electronic device 102 with an average grade of the first grade information to the fourth grade information.

The first electronic device 101 may obtain second information indicating the number of one or more virtual machines to be executed in the second electronic device 102 based on the total grade information of the second electronic device 102. For example, the higher the total grade of the second electronic device 102, the more virtual machines may be executed in the second electronic device 102.

In operation 1130, in response to obtaining of the second information, the first electronic device 101 may transmit a first signal to the second electronic device 102 for executing one or more virtual machines of number indicated by the second information in the first mode.

For example, the first mode may be distinct from the second mode in which the virtual machine provides graphic data to any one of the external electronic devices. In other words, the first mode may be a mode in which the virtual machine does not provide graphic data to any one of the external electronic devices.

As an example, in the first mode, the second electronic device 102 may not provide graphic data to any one of the external electronic devices through one or more virtual machines executed in the second electronic device 102. In other words, the second electronic device 102 may execute one or more virtual machines in the first mode and operate in a standby state.

As another example, In the second mode, the second electronic device 102 may provide graphic data to any one of the external electronic devices through one or more virtual machines executed in the second electronic device 102. In other words, the second electronic device 102 may execute one or more virtual machines in the second mode. In addition, the second electronic device 102 may generate graphic data through one or more virtual machines and provide the generated graphic data to any one of the external electronic devices.

In operation 1140, after transmitting the first signal, the first electronic device 101 may identify an event for adjusting the number of one or more virtual machines indicated by the second information.

For example, the event for adjusting the number of one or more virtual machines may comprise an event in which the total grade information of the second electronic device 102 is changed.

Resources of the second electronic device 102 may be changed over time. The network environment of the second electronic device 102 may change, or the second electronic device 102 may be used to execute other applications distinct from executing one or more virtual machines. Accordingly, based on a change in the resources of the second electronic device 102, the total grade information of the second electronic device 102 may be changed. The first electronic device 101 may identify that the total grade information of the second electronic device 102 is changed.

For another example, the event for adjusting the number of one or more virtual machines may be determined based on the number of at least one external electronic device operating in an operation mode for displaying graphic data provided from the second electronic device 102 among external electronic devices.

At least some of the one or more virtual machines executed in the second electronic device 102 may be used to transmit graphic data to at least one external electronic device operating in the operation mode. Accordingly, an event for adjusting the number of one or more virtual machines may be determined based on the number of at least one external electronic device operating in the operation mode.

As an example, the event for adjusting the number of one or more virtual machines may comprise an event in which a time when the one or more virtual machines are executed is switched from a first time interval to a second time interval.

As an example, the first electronic device 101 may learn data on the number of at least one external electronic device operating in the operation mode. The first electronic device 101 may determine an event for adjusting the number of one or more virtual machines based on the learned data. The first electronic device 101 may determine (or predict) a first time interval and a second time interval based on the learned data.

The second time interval may mean a time interval in which the number of at least one external electronic device operating in the operation mode increases compared to the first time interval. That is, the first electronic device 101 may determine a second time interval in which the number of at least one external electronic device operating in the operation mode is increased based on the learned data, and may identify an event in which the execution time of one or more virtual machines is switched from the first time interval to the second time interval.

In operation 1150, the first electronic device 101, in response to the identification of the event, may obtain third information for adjusting the number of one or more virtual machines indicated by the second information and executed in the second electronic device 102.

For example, the first electronic device 101 may identify that the grade information of the second electronic device 102 is changed. The first electronic device 101 may obtain third information for adjusting the number of one or more virtual machines executed in the second electronic device 102 based on a change in the total grade information of the second electronic device 102.

For another example, the first electronic device 101 may identify that the time at which the one or more virtual machines are executed is switched from the first time interval to the second time interval. The first electronic device 101 may obtain third information for adjusting the number of one or more virtual machines being executed in the second electronic device 102 based on the time when the one or more virtual machines execute identifies the switch from the first time interval to the second time interval.

In operation 1160, in response to obtaining of the third information, to the second electronic device, the first electronic device 101 may transmit a second signal for adjusting the number of the one or more virtual machines being executed in the first mode based on the second information.

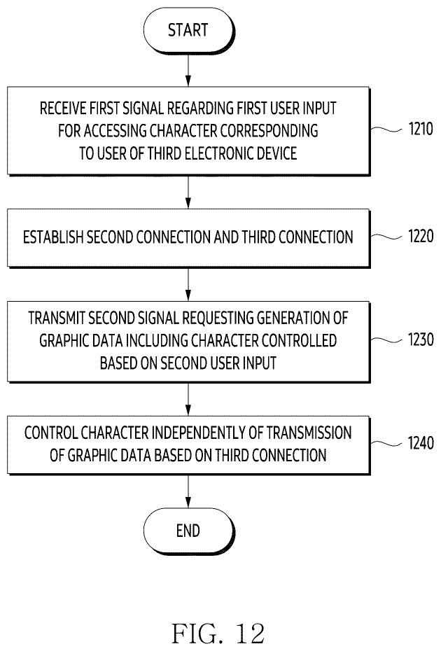

FIG. 12 is a flowchart illustrating an example of an operation of a first electronic device according to various embodiments.

Referring to FIG. 12, in operation 1210, from the third electronic device 103 distinct from the first electronic device 101, through a first connection between the first electronic device 101 and the third electronic device 103, the first electronic device 101 may receive a first signal regarding a first user input for accessing a character corresponding to a user of the third electronic device 103.

According to an embodiment, the first user input may comprise an input for logging in to an application executed in the third electronic device 103. The first electronic device 101 may establish a first connection based on the first user input of the third electronic device 103. The first electronic device 101 may receive a first signal related to the first user input through the first connection.

Based on the first user input, the first electronic device 101 may receive a signal for requesting establishment of a session based on an account indicated by the user input from the third electronic device 103. In response to the request, the first electronic device 101 may establish a session based on the account with the third electronic device 103. The first electronic device 101 may store information on the third electronic device 103 indicated by the session in a storing device (e.g., memory) of the first electronic device 101.

In operation 1220, in response to reception of the first signal, the first electronic device 101 may establish a second connection between the second electronic device 102 and the first electronic device 101 distinct from the third electronic device 103 and a third connection for transmitting graphic data from the third electronic device 103 to the second electronic device 102.

For example, the second connection may be used to transmit information on the control of the character. The first electronic device 101 may receive a second user input related to control of the character from the second electronic device 102 through a second connection.

For example, the third connection may mean a connection between the second electronic device 102 and the third electronic device 103. In addition, the third connection may be used to transmit graphic data generated in the second electronic device 102 to the third electronic device 103.

In operation 1230, in the first state where the first connection, the second connection, and the third connection are established, in response to identifying the second user input by the third electronic device 103 through the first connection, the first electronic device 101 may transmit a second signal for requesting generation of the graphic data including the character controlled based on a second user input to the second electronic device 102 through a second connection.

For example, the first state may mean a state in which a first connection, a second connection, and a third connection are established. The second state may mean a state in which at least one of the first connection, the second connection, and the third connection is released.

For example, the first electronic device 101 may identify a second user input by the third electronic device 103 through a first connection.

The second user input may be variously configured. As an example, the second user input may comprise an input related to motion of a character in an application (e.g., an online game), an input related to an attack of a character, an input related to a defense of the character, or an input related to a conversation of the character.

The first electronic device 101 may receive a signal indicating that the second user input is received through the first connection. The first electronic device 101 may perform data processing for controlling the character based on a second user input by the third electronic device 103. For example, the first electronic device 101 may perform data processing for changing a motion of a character according to a second user input.

For example, the second electronic device 102 may generate graphic data including the character based on a data processing result for controlling the character performed in the first electronic device 101. Accordingly, after performing data processing for controlling the character, the first electronic device 101 may transmit a second signal for requesting generation of graphic data including the controlled character based on a second user input.

In operation 1240, the first electronic device 101 may control the character independently of transmission of the graphic data based on the third connection in response to identifying entering the second state distinct from the first state.

The first electronic device 101 may identify entering a second state distinct from the first state. For example, the first electronic device 101 may identify a third user input by the third electronic device 103.

For example, the third user input may comprise an input for changing an operation mode of the third electronic device 103. The third electronic device 103 may operate in one of three operation modes. In the first operation mode, the third electronic device 103 may receive a second user input for controlling a character and may receive graphic data from the second electronic device 102 based on the second user input. In the second operation mode, the third electronic device 103 may maintain an access state of the character without receiving a second user input for controlling the character. The third electronic device 103 may release access of the character in the third operation mode. As an example, the third user input may comprise an input for changing the operation mode of the third electronic device 103 from the first operation mode to the second operation mode.

The first electronic device 101 may transmit a signal for releasing the second connection and the third connection based on the third user input. As an example, the signal may be transmitted to the second electronic device 102. As another example, the signal may be transmitted to both the second electronic device 102 and the third electronic device 103. Based on the release of the second connection and the third connection, the first electronic device 101 may identify entering a second state distinct from the first state.

For example, the first electronic device 101 may control the character regardless of transmission of graphic data based on the third connection. As an example, the first electronic device 101 may control the character even in a state in which graphic data is not transmitted from the second electronic device 102 to the third electronic device 103 because the third connection between the second electronic device 102 and the third electronic device 103 is released. That is, independently of transmission of graphic data, the first electronic device 101 may maintain data processing for controlling the character.

According to an embodiment, the first electronic device 101 may identify a fourth user input by the third electronic device 103. For example, the fourth user input may comprise a user input for changing the operation mode of the third electronic device 103 from the second operation mode to the first operation mode.

The first electronic device 101 may re-establish the second connection in response to identifying the fourth user input. Independently of transmission of graphic data based on the third connection, information on a character controlled by the first electronic device 101 may be transmitted to the second electronic device 102.

For example, the first electronic device 101 may control the character even in a state in which the second connection is released, and may store information about the controlled character. The first electronic device 101 may re-establish a second connection with the second electronic device 102, and may transmit information about the controlled character to the second electronic device 102. Accordingly, the first electronic device 101 may establish a connection with the second electronic device 102 again in order to transmit graphic data to the third electronic device 103 based on the fourth user input. In an embodiment, the first electronic device 101 may transmit information related to the third electronic device 103 indicated by the session stored in the first electronic device 101. Based on the information related to the third electronic device 103 indicated by the session, the second electronic device 102 may re-establish a connection for transmitting graphic data with the third electronic device 103.

According to an embodiment, the first electronic device 101 may identify a fifth user input by the third electronic device 103. For example, the fifth user input may comprise a user input for changing the operation mode of the third electronic device 103 from the second operation mode to the first operation mode. In response to identifying the fifth user input by the third electronic device 103, the first electronic device 101 may establish a connection with the fourth electronic device distinct from the second electronic device 102. In an embodiment, the first electronic device 101 may transmit information related to the third electronic device 103 indicated by the session stored in the first electronic device 101 to the fourth electronic device. Based on the information related to the third electronic device 103 indicated by the session, the fourth electronic device may establish a connection for transmitting graphic data with the third electronic device 103.

The first electronic device 101 may transmit information about the character controlled by the first electronic device 101 to the fourth electronic device independently of transmission of graphic data based on the third connection. Accordingly, based on the fifth user input, the first electronic device 101 may change the electronic device for transmitting graphic data to the third electronic device 103 from the second electronic device 102 to the fourth electronic device.

According to an embodiment, the first electronic device 101 may identify that a signal related to a user input from the third electronic device 103 is not received during the first time interval. The first electronic device 101 may release the second connection and the third connection based on the fact that the signal regarding the user input from the third electronic device 103 is not received during the first time interval. The first electronic device 101 may maintain access to a character corresponding to a user of the third electronic device.

For example, the first electronic device 101 may identify that a signal regarding a user input is not received from the third electronic device 103 during a first time interval, and may transmit a signal for changing an operation mode of the third electronic device 103 from the first mode to the second mode. Based on the signal, the first electronic device 101 may release the second connection and the third connection.

For another example, based on the fact that the signal regarding the user input from the third electronic device 103 is not received during the first time interval, the first electronic device 101 may receive a signal for requesting release of the third connection from the third electronic device 103. Based on a signal for requesting the release of the third connection, the first electronic device 101 may release the second connection and the third connection.

For example, after the first time interval has elapsed, based on the fact that a signal regarding the user input is not received from the third electronic device 103 during the second time interval, the first electronic device 101 may release access to a character corresponding to a user of the third electronic device 103 and may stop controlling the character. As an example, after the first time interval has elapsed, based on the fact that a signal regarding the user input is not received from the third electronic device 103 during the second time interval, the first electronic device 101 may change the operation mode of the third electronic device 103 from the second mode to the third mode.

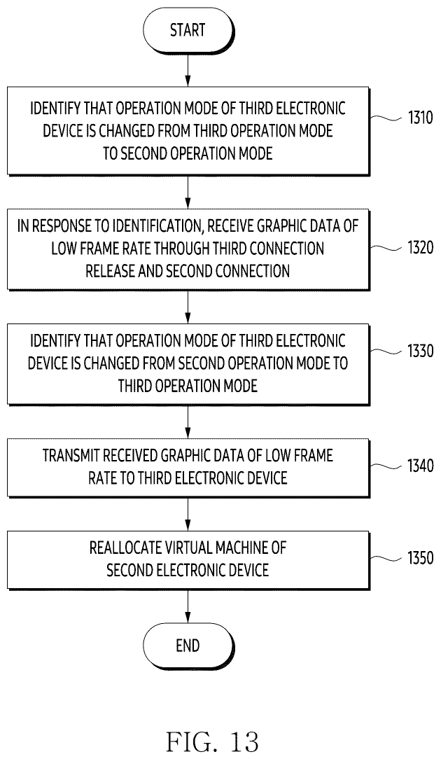

FIG. 13 is a flowchart illustrating an example of an operation of a first electronic device according to various embodiments.

Referring to FIG. 13, in operation 1310, the first electronic device 101 may identify that the operation mode of the third electronic device 103 is changed from the third operation mode to the second operation mode.

For example, the third electronic device 103 may receive graphic data through the virtual machine of the second electronic device 102 in the third operation mode of the third electronic device 103. Thereafter, the operation mode of the third electronic device 103 may be changed from the third operation mode to the second operation mode based on the first user input.

In operation 1320, the first electronic device 101 may release the third connection between the second electronic device 102 and the third electronic device 103 in response to the identification. The first electronic device 101 may maintain the second connection between the first electronic device 101 and the second electronic device 102. After the connection between the second electronic device 102 and the third electronic device 103 is released, the first electronic device 101 may receive graphic data having a frame rate lower than a frame rate before the connection is released through the second connection.

For example, while the second electronic device 102 transmits graphic data to the third electronic device 103, the third connection may be released. Thereafter, the second electronic device 102 may transmit graphic data transmitted to the third electronic device 103 to the first electronic device 101. The graphic data transmitted to the first electronic device 101 may be set to a frame rate lower than a frame rate of the graphic data transmitted to the third electronic device 103.

Accordingly, the first electronic device 101 may release the third connection in response to the identification and may receive graphic data having a low frame rate through the second connection. The first electronic device 101 may receive graphic data with a low frame rate and may store the received graphic data in a memory of the first electronic device 101.

In operation 1330, the first electronic device 101 may identify that the operation mode of the third electronic device 103 is changed from the second operation mode to the third operation mode. For example, the operation mode of the third electronic device 103 may be changed from the second operation mode to the third operation mode based on the second user input. Thereafter, the first electronic device 101 may identify that the operation mode of the third electronic device 103 is changed from the second operation mode to the third operation mode.

In operation 1340, the first electronic device 101 may transmit graphic data received from the second electronic device 102 to the third electronic device 103. The first electronic device 101 may transmit stored graphic data of a low frame rate in response to a change in the operation mode of the third electronic device 103. Accordingly, when the operation mode of the third electronic device 103 is changed by the first electronic device 101 transmitting graphic data having a low frame rate, there is an effect that a screen delay does not occur.

In operation 1350, after transmitting the received graphic data to the third electronic device 103, the first electronic device 101 may reallocate the virtual machine of the second electronic device 102 to transmit the graphic data to the third electronic device 103. For example, the virtual machine may be set to one of one or more virtual machines in the second electronic device 102. Accordingly, a virtual machine generating graphic data having a low frame rate in the second electronic device 102 may be reallocated, or a virtual machine not generating graphic data having the low frame rate in the second electronic device 102 may be newly allocated.

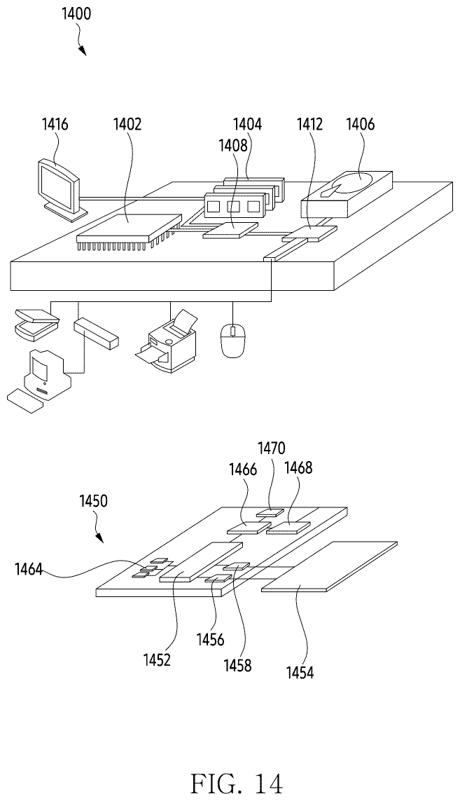

FIG. 14 is a simplified block diagram illustrating functional configurations of each of electronic devices according to various embodiments.

Referring to FIG. 14, the electronic device 1400 may be an example of a first electronic device 101, a second electronic device 102, or a third electronic device 103. The electronic device 1400 may comprise a processor 1402, a memory 1404, a storing device 1406, a high-speed controller 1408 (e.g., a Northbridge, a main controller hub (MCH), and a low-speed controller 1412 (e.g., a Southbridge, an I/O (input/output) controller hub (ICH)). In the electronic device 1400, each of the processor 1402, the memory 1404, the storing device 1406, the high-speed controller 1408, and the low-speed controller 1412 may be interconnected using various buses.

For example, the processor 1402 may process instructions for execution within the electronic device 1400 to display graphic information on the graphical user interface (GUI) on an external input/output device such as a display 1416 connected to the high-speed controller 1408. The instructions may be comprised in the memory 1404 or the storing device 1406. The instructions may cause the electronic device 1400 to perform the above-described one or more operations and/or one or more operations to be described below when executed by the processor 1402. According to embodiments, the processor 1402 may comprise a plurality of processors including a communication processor and a graphical processing unit (GPU).

For example, the memory 1404 may store information in the electronic device 1400. For example, the memory 1404 may be a volatile memory unit or units. As another example, the memory 1404 may be a nonvolatile memory unit or units. As another example, memory 1404 may be another type of computer-readable medium, such as a magnetic or optical disk.

For example, the storing device 1406 may provide a mass storage space to the electronic device 1400. For example, the storing device 1406 may be a computer-readable medium such as a hard disk device, an optical disk device, a flash memory, a solid state memory device, or an array of devices in a storage area network (SAN).

For example, the high-speed controller 1408 may manage bandwidth-intensive operations for the electronic device 1400, while the low-speed controller 1412 may manage low-bandwidth intensive operations for the electronic device 1400. For example, the high-speed controller 1408 is coupled to the memory 1404 and is coupled to the display 1416 through a GPU or accelerator, while the low-speed controller 1412 may be coupled to the storing device 1406 and may be coupled to various communication ports (e.g., universal serial bus (USB), Bluetooth, Ethernet, wireless Ethernet) for communication with external electronic devices (e.g., keyboards, transducers, scanners, or network devices (e.g., switches or routers).

The electronic device 1450 may be an example of the third electronic device 103. The electronic device 1450 may comprise an input/output device such as a processor 1452, a memory 1464, a display 1454 (e.g., an organic light emitting diode (OLED) display or other suitable display), a communication interface 1466, and a transceiver 1468. Each of the processor 1452, the memory 1464, the input/output device, the communication interface 1466, and the transceiver 1468 may be interconnected using various buses.

For example, the processor 1452 may process instructions comprised in the memory 1464 to display graphic information on the GUI on the input/output device. The instructions may cause the electronic device 1450 to perform the above-described one or more operations and/or one or more operations to be described below when executed by the processor 1452. For example, the processor 1452 may interact with the user through the display interface 1456 and the control interface 1458 combined with the display 1454. For example, the display interface 1456 may comprise a circuit for driving the display 1454 to provide visual information to the user, and the control interface 1458 may comprise a circuit for receiving commands received from a user and for converting the commands for providing to processor 1452. According to embodiments, the processor 1452 may be implemented as a chipset of chips including analog and digital processors.

For example, the memory 1464 may store information in the electronic device 1450. For example, the memory 1464 may comprise at least one of one or more volatile memory units, one or more nonvolatile memory units, or a computer-readable medium.

For example, based on interworking with the processor 1452, the communication interface 1466 may perform wireless communication between the electronic device 1450 and an external electronic device through various communication techniques such as cellular communication technique, Wi-Fi communication technique, NFC technique, or Bluetooth communication technique. For example, communication interface 1466 may be coupled to transceiver 1468 to perform the wireless communication. For example, the communication interface 1466 may be further coupled to a global navigation satellite system (GNSS) receiving module 1470 to obtain location information of the electronic device 1450.

The one or more programs of a computer-readable storage medium storing one or more programs according to various embodiments, when being executed by at least one processor of a first electronic device 101 with a communication circuit, may include instructions cause the first electronic device 101 to identify first information indicating a resource of a second electronic device 102, obtain, based on the first information, second information indicating the number of one or more virtual machines to be executed in the second electronic device 102, in response to obtaining the second information, transmit a first signal for executing, in a first mode, the number of one or more virtual machines indicated by the second information, to the second electronic device 102, wherein the first mode is distinct from a second mode in which a virtual machine provides graphic data to one of the external electronic devices, after transmitting the first signal, identify an event for adjusting the number of the one or more virtual machines indicated by the second information; in response to the identification of the event, obtain third information for adjusting the number of the one or more virtual machines executing on the second electronic device 102, indicated by the second information, and in response to obtaining the third information, transmit to the second electronic device 102 a second signal for adjusting the number of the one or more virtual machines executing in the first mode based on the second information.

According to an embodiment, the resource of the second electronic device 102 may be set based on information on a central processing unit of the second electronic device 102, information on a graphic processing unit of the second electronic device 102, information on a storage device of the second electronic device 102, and information on a network state of the second electronic device 102.

According to one embodiment, the one or more programs, may include instructions cause the first electronic device 101 to identify, based on the information on the central processing unit, first grade information, identify, based on the information on the graphic processing device, second grade information, identify, based on the information on the storage device, third grade information, identify, based on the information on the network state, fourth grade information, identify, based on the first grade information to the fourth grade information, total grade information of the second electronic device 102, and obtain, based on the total grade information of the second electronic device 102, the second information indicating the number of the one or more virtual machines to be executed in the second electronic device 102.

According to an embodiment, the event for adjusting the number of the one or more virtual machines may include an event in which the total grade information of the second electronic device 102 is changed.

According to an embodiment, the event for adjusting the number of the one or more virtual machines may be determined based on the number of at least one external electronic device operating in an operation mode for displaying the graphic data provided from the second electronic device 102, among the external electronic devices.

According to an embodiment, the event for adjusting the number of the one or more virtual machines may include an event in which execution time of the one or more virtual machines is switched from a first time interval to a second time interval.

According to an embodiment, the one or more programs may include instructions cause the first electronic device 101 to learn data related to the number of the at least one external electronic device operating in the operation mode, and determine, based on the data, the first time interval and the second time interval.

The one or more programs of a computer-readable storage medium storing one or more programs according to various embodiments, when being executed by at least one processor of a first electronic device 101 with a communication circuit, may include instructions cause the first electronic device 101 to receive, from a third electronic device 103 distinct from the first electronic device 101, a first signal related to a user input to access a character corresponding to a user of the third electronic device 103 through a first connection between the first electronic device 101 and the third electronic device 103, in response to receiving the first signal, establish a second connection between the first electronic device 101 and a second electronic device 102 distinct from the third electronic device 103 and third connection for transmission of graphic data from the third electronic device 103 to the second electronic device 102, in a first state in which the first connection, the second connection, and the third connection are established, in response to identifying a second user input by the third electronic device 103 through the first connection, transmit a second signal for requesting generation of the graphic data including the character controlled based on the second user input to the second electronic device 102 through the second connection, and in response to identifying entering a second state distinct from the first state, control the character independently of the transmission of the graphic data based on the third connection.

According to an embodiment, the one or more programs, based on a third user input by the third electronic device 103, may further include instructions cause the first electronic device 101 to transmit a third signal for releasing the second connection and the third connection.

According to one embodiment, one or more programs may further include instructions cause the first electronic device 101 to in response to identifying a fourth user input by the third electronic device 103, select a fourth electronic device that generates the graphic data among other electronic devices that include the second electronic device 102 and are distinct from the first electronic device 101, and in response to selecting the fourth electronic device, transmit, to the selected fourth electronic device, a fourth signal for establishing a connection between the first electronic device 101 and the fourth electronic device.

According to one embodiment, the one or more programs may further include instructions cause the first electronic device 101 to in response to identifying a fourth user input by the third electronic device 103, establish a connection with a fourth electronic device distinct from the second electronic device 102, and transmit information on a character controlled by the first electronic device 101 to the fourth electronic device independently of the transmission of the graphic data based on the third connection.

According to one embodiment, the graphic data may be used to be displayed through a display of the third electronic device 103.

According to one embodiment, the one or more programs may further include instructions cause the first electronic device 101 to disconnect, based on that a signal regarding a user input is not received from the third electronic device 103 for a first time interval, the second connection and the third connection, and maintain access to the character corresponding to the user of the third electronic device 103.

According to one embodiment, the one or more programs may further include instructions cause the first electronic device 101 to releases the access to the character corresponding to the user of the third electronic device 103 and stop controlling the character based on that the signal regarding a user input is not received from the third electronic device 103 for the second time interval after the first time interval has elapsed.

According to one embodiment, a method for a first electronic device 101 with at least one memory and a communication circuit may comprise identifying first information indicating a resource of a second electronic device 102, obtaining, based on the first information, second information indicating the number of one or more virtual machines to be executed in the second electronic device 102, in response to obtaining the second information, transmitting a first signal for executing, in a first mode, the number of one or more virtual machines indicated by the second information, to the second electronic device 102, wherein the first mode is distinct from a second mode in which a virtual machine provides graphic data to one of the external electronic devices, after transmitting the first signal, identifying an event for adjusting the number of the one or more virtual machines indicated by the second information; in response to the identification of the event, obtaining third information for adjusting the number of the one or more virtual machines executing on the second electronic device 102, indicated by the second information, and in response to obtaining the third information, transmitting to the second electronic device 102 a second signal for adjusting the number of the one or more virtual machines executing in the first mode based on the second information.

According to one embodiment, the resource of the second electronic device 102, may be set based on information on a central processing unit of the second electronic device 102, information on a graphic processing unit of the second electronic device 102, information on a storage device of the second electronic device 102, and information on a network state of the second electronic device 102.

According to one embodiment, the method may further comprise identifying, based on the information on the central processing unit, first grade information, identifying, based on the information on the graphic processing device, second grade information, identifying, based on the information on the storage device, third grade information, identifying, based on the information on the network state, fourth grade information, identifying, based on the first grade information to the fourth grade information, total grade information of the second electronic device 102, and obtaining, based on the total grade information of the second electronic device 102, the second information indicating the number of the one or more virtual machines to be executed in the second electronic device 102.

According to one embodiment, the event for adjusting the number of the one or more virtual machines may be determined based on the number of at least one external electronic device operating in an operation mode for displaying the graphic data provided from the second electronic device 102, among the external electronic devices.

According to one embodiment, the event for adjusting the number of the one or more virtual machines may include an event in which execution time of the one or more virtual machines is switched from a first time interval to a second time interval.

According to one embodiment, the method may further comprise learning data related to the number of the at least one external electronic device operating in the operation mode, and determining, based on the data, the first time interval and the second time interval.

Methods according to the embodiments described in the claims or specifications of the present disclosure may be implemented in the form of hardware, software, or a combination of hardware and software.

When implemented as software, a computer-readable storage medium may be provided that stores one or more programs (software modules). One or more programs stored in a computer-readable storage medium are configured for execution by one or more processors in an electronic device. One or more programs comprise instructions that cause the electronic device to execute methods according to the embodiments described in the claims or specification of the present disclosure.

One or more of these programs (software modules, software) may be stored in a memory configured as non-volatile memory comprising random access memory and flash memory, Read Only Memory (ROM), Electrically Erasable Programmable Read Only Memory (EEPROM), magnetic disc storage device, optical storage device (e.g., CD-ROM: Compact Disc-Rom), DVD: Digital Versatile Discs), magnetic cassettes, or a combination thereof. Alternatively, it may be stored in a memory composed of a combination of some or all of them. In addition, the program may be stored in an attachable storage device that may be accessed through a communication network such as Internet, Intranet, Local Area Network (LAN), Wide LAN (WLAN), Storage Area Network (SAN), or a combination thereof. Such a storage device may access a device performing an embodiment of the present disclosure through an external port. In addition, a separate storage device on the communication network may access a device performing an embodiment of the present disclosure.

In specific embodiments of the present disclosure described above, components of the electronic device comprised in the present disclosure have been expressed in single or plural according to the specific embodiments presented. However, singular or plural expressions for the above components are appropriately selected for the situation for the convenience of explanation, and the present disclosure is not limited to singular or plural components. Therefore, components expressed in plural may be configured as single and components expressed in single may be configured as plural.

Meanwhile, the detailed embodiments have been described in the detailed description of the present disclosure, but it goes without saying that various modifications can be made within the limit not departing from the scope of the present disclosure. Therefore, the scope of the present disclosure should not be limited to the described embodiments but should be determined by the scope of the claim to be described later as well as those equivalent to the scope of the claim.

What is claimed is:

1. A computer readable storage medium storing one or more programs, the one or more programs including instructions, which, when being executed by at least one processor of a first electronic device with a communication circuit, cause the first electronic device to:
receive, from a third electronic device distinct from the first electronic device, a first signal related to a user input to access a character corresponding to a user of the third electronic device through a first connection between the first electronic device and the third electronic device,
in response to receiving the first signal, establish a second connection between the first electronic device and a second electronic device distinct from the third electronic device and third connection for transmission of graphic data from the third electronic device to the second electronic device,
in a first state in which the first connection, the second connection, and the third connection are established, in response to identifying a second user input by the third electronic device through the first connection, transmit a second signal for requesting generation of the graphic data including the character controlled based on the second user input to the second electronic device through the second connection, and
in response to identifying entering a second state distinct from the first state, control the character independently of the transmission of the graphic data based on the third connection.

2. The computer readable storage medium according to claim 1, based on a third user input by the third electronic device, wherein the one or more programs further include instructions cause the first electronic device to transmit a third signal for releasing the second connection and the third connection.

3. The computer readable storage medium according to claim 2, wherein the one or more programs further include instructions cause the first electronic device to
in response to identifying a fourth user input by the third electronic device, select a fourth electronic device that generates the graphic data among other electronic devices that include the second electronic device and are distinct from the first electronic device, and
in response to selecting the fourth electronic device, transmit, to the selected fourth electronic device, a fourth signal for establishing a connection between the first electronic device and the fourth electronic device.

4. The computer readable storage medium according to claim 2, wherein the one or more programs further include instructions cause the first electronic device to:
in response to identifying a fourth user input by the third electronic device, establish a connection with a fourth electronic device distinct from the second electronic device, and
transmit information on a character controlled by the first electronic device to the fourth electronic device independently of the transmission of the graphic data based on the third connection.

5. The computer readable storage medium according to claim 1, wherein the graphic data is used to be displayed through a display of the third electronic device.

6. The computer readable storage medium according to claim 1, wherein the one or more programs further include instructions cause the first electronic device to
disconnect, based on that a signal regarding a user input is not received from the third electronic device for a first time interval, the second connection and the third connection, and
maintain access to the character corresponding to the user of the third electronic device.

7. The computer readable storage medium according to claim 6, wherein the one or more programs further include instructions cause the first electronic device to
releases the access to the character corresponding to the user of the third electronic device and stop controlling the character based on that the signal regarding a user input is not received from the third electronic device for the second time interval after the first time interval has elapsed.
